(19) United States
(12) Patent Application Publication
(10) Pub. No.: US 2011/0240837 A1
(43) Pub. Date: Oct. 6, 2011

(54) NEUTRON BEAM FORMING USING MOMENTUM TRANSFER

(75) Inventor: Wayne B. Norris, Santa Barbara, CA (US)

(73) Assignee: BOSS PHYSICAL SCIENCES LLC, Troy, MI (US)

(21) Appl. No.: 13/130,778

(22) PCT Filed: Nov. 24, 2009
(86) PCT No.: PCT/US2009/065680

§ 371 Date: May 24, 2011

Related U.S. Application Data
(60) Provisional application No. 61/117,295, filed on Nov. 24, 2008.

(51) Int. Cl. H05H 3/02

(52) U.S. Cl. 250/251

(57) ABSTRACT

Apparatus and methods for forming thermal, epithermal, and/or cold neutrons into a beam using momentum transfer. The apparatus includes a source of thermal, epithermal, or cold neutrons, a momentum transfer mechanism containing a collection of suitable atoms that collide elastically with the neutrons, and an apparatus for moving the momentum transfer medium in a preferred direction. The embodiments include locating the neutron source within the test section of a wind tunnel filled with a gas consisting of appropriate atoms, either supersonic, transonic, or subsonic, locating the neutron source in the midst of multiple rotors constructed of appropriate atoms, and locating the neutron source inside a tube constructed of appropriate atoms, where the tube is excited by a mechanical transducer to a bulk acoustic wave, while the neutron source is optionally switched off and on to cause neutrons to enter the tube walls only when the tube walls are moving in the preferred direction.

### FIELD OF THE INVENTION

The present disclosure relates generally to methods for controlling a neutron beam of the type used for various applications, and more particularly to beam forming of thermal, epithermal, and cold neutrons using momentum transfer techniques.

### BACKGROUND

The use of neutrons for multiple purposes is an emerging technology. For most such purposes, neutrons generally must be formed into beams. As one example, thermal, epithermal, or cold neutron beams can be used to detect hidden explosive substances at standoff ranges, up to about 20 meters. As another example, thermal, epithermal, or cold neutron beams can be used for the grading of coal as it is produced from the ground, based on heat content and associated mineral content. As yet another example, thermal, epithermal, or cold neutron beams can be used for the detection of valuable elements such as rhenium and hafnium in either mine tailings, undisturbed ground, or recently exposed surfaces. As yet another example, thermal, epithermal, or cold neutron beams can be used for medical therapies such as boron neutron capture therapy (“BNCT”) or for medical or industrial imaging. Those skilled in the art will recognize that other applications exist.

However, thermal, epithermal, or cold neutron sources are essentially all isotropic—that is, such sources emit neutrons approximately equally in all directions. Due to their lack of electric charge, neutrons are extremely difficult to direct into beams, and the ability to form them into beams has been sought after for many years. Prior techniques include the use of hexapole magnets, capillary tubes, and atomic diffraction, among others, but none of these is suitable for large fluxes, moderate costs, or mobile or remote applications.

As disclosed in the applicant's co-pending U.S. patent application Ser. No. 12/503,300, Filed: Jul. 15, 2009, the entire disclosure of which is hereby incorporated by reference and relied upon, a source of fast neutrons can be used to produce thermal, epithermal, or cold neutrons, which are then collimated to produce a beam. Not all such neutrons become a part of the beam, however. Neutrons that cannot be made a part of the beam are wasted, reducing the efficiency of the device. The wasted neutrons also require the use of more shielding in the device, to limit their effects on the surrounding environment and on the sensors contained in the device itself.

Thermal neutrons are those neutrons whose mean energy approximates the energy associated with molecules at a room temperature of 298.16 K, 0.025693 eV, corresponding to 4.11655×10-21 Joules and are generally approximated as 0.026 eV. Such neutrons are in thermal equilibrium with room temperature surroundings. Thermal neutrons, as with all particles with similar thermal behavior, have velocities distributed according to a Maxwell-Boltzmann distribution, with mean velocity of 2,217.1 m/sec, which is generally approximated as 2,200 m/sec. This corresponds to a momentum of 3.7135×10⁻²⁴ kg-m/sec. While low in comparison to the speed of energetic neutrons, it should be noted that 2,200 meters per second corresponds to Mach 6.4 based on the speed of sound in air at STP.

Cold neutrons are defined as those neutrons whose mean energies range from 5×10⁻⁵ eV, corresponding to 0.58 K, to just below that of thermal neutrons. Mean velocities of cold neutrons range from 98 m/sec to just under thermal mean velocities. Mean momenta of cold neutrons range from 1.64×10⁻²⁵ kg-m/sec to just under thermal neutron momenta.

Epithermal neutrons are defined as those neutrons whose mean energies range from just above those of thermal neutrons to 1 eV, corresponding to 11,605 K. Mean velocities of epithermal neutrons range from just over thermal mean velocities to 13,832 m/sec. Mean momenta of epithermal neutrons range from just above thermal neutron momenta to 2.32×10⁻²³ kg-m/sec.

There is therefore a need in the art to direct beams of neutrons in a desired direction using methods that are compatible with multiple applications, large flux ranges, and that are conducive to mobile/deployable/remote embodiments.

### SUMMARY OF THE INVENTION

The present invention is directed to an apparatus and method for forming neutrons into beams, including but not limited to those classed as thermal, epithermal, or cold, by transferring to those neutrons momentum components in the preferred beam direction by means of elastic scattering from the nuclei of atoms that are moving in the preferred direction. This method offers the ability to redirect significant percentages of the flux of a neutron beam to a desired direction.

Briefly, the disclosed invention comprises a device and method for moving suitable atoms, in either a fluid stream or solid form, relative to the neutron source at relatively high speeds, ideally of the order of the mean speeds of the neutrons themselves, and allowing the neutrons and moving atoms to interact via elastic scattering. For descriptive purposes, elastic scattering of neutrons from nuclei may be compared to the extremely simple case of classical collisions of billiard balls with one another, like that shown in FIG. 5. During scattering collisions, the atoms transfer linear momentum to the initially isotropically directed thermal or cold neutrons, causing those neutrons to attain, on balance, momentum in the direction of the passing atoms. It should be noted that motion of the atoms in the above described stream also includes random thermal components, with the result that momentum transfer from the stream of atoms to the neutrons includes a statistically random component.

Momentum transfer from the atoms to the neutrons is most efficient when: a) the ratio of the atomic stream velocity to the neutron velocity is highest; b) the atomic weight of the atomic stream nuclei is highest; and c) the mean free path of the neutrons in the atomic stream is lowest. These conditions dictate a dense, extremely fast-moving stream of atoms with the highest practical atomic number.

The actual velocities and corresponding speeds of individual thermal, epithermal, or cold neutrons emanating from a neutron source are distributed over a wide range of values. This is because the neutrons have been slowed down—“cooled”—by contact with a moderator that imparted a Maxwell-Boltzmann energy distribution on them. Thus, thermal, epithermal, or cold neutrons emanating from a source have a mix of energies, including some with low energies, some with medium energies, and some with high energies. Those neutrons with the lowest energies in the spectrum are the most likely to have their paths steered toward the preferred direction by the present invention; those with medium energies are less likely to be steered, and those with high energies are the least likely.

In addition to experiencing simple elastic scattering reactions, thermal, epithermal, and cold neutrons also interact with most nuclides or nuclear species by causing nuclear reactions. Such nuclear reactions may consume neutrons and/or produce secondary effects such as activation products, gamma rays, or other particles. Neutrons consumed in this way are not available for use in other ways. Further, any secondary products may present themselves as nuisances.

A limited number of nuclides, notably deuterium (²H or ²D), helium-4 (⁴He), carbon-12 (¹²C) and oxygen-16 (¹⁶O), have extremely low nuclear reaction probabilities with thermal, epithermal, or cold neutrons, with the result that these nuclides interact with thermal, epithermal, or cold neutrons nearly exclusively by means of simple elastic scattering. These materials result in the lowest number of secondary reactions.

To avoid excessive neutron loss due to nuclear events, atomic species with the lowest thermal, epithermal, or cold nuclear reactions are generally the preferred nuclei to use for the linear momentum transfer described above. In some embodiments, the use of compounds of the elements containing the preferred nuclei are a practical way to implement momentum transfer to neutrons.

Since the nuclei used for neutron beam steering via elastic scattering momentum transfer may be configured as either solid structures or as fluids, it is appropriate to discuss them generically as a “collection” of nuclei for economy of wording, since that term subsumes all their useful structures, fluids, and other possible arrangements. For purposes of this disclosure, the term “collection” will be used to mean any solid, liquid, gas, or plasma containing the nuclei to be used for the deflection of neutrons toward a preferred direction by means of momentum transfer.

Embodiments of the present invention include collections of atoms in both the gaseous phase and in the solid phase, although liquid phase and plasma phase collections are also foreseeable. Embodiments in the gaseous phase include pure elements deuterium (D₂), helium (He), and oxygen (O₂) and compounds heavy water vapor (D₂O), carbon dioxide (CO₂), and deuterated methane (CD₄). Embodiments in the solid phase include carbon fiber composites, carbon nanostructure compounds (CO, and deuterated polyethylene ((CD₂)ₙ).

Momentum transfer from a collection of atoms in a desired direction for a thermal, epithermal, or cold neutron beam to the neutrons themselves may be accomplished with multiple embodiments. Such embodiments include, but are not limited to, streaming a fluid of suitable atoms past a source of neutrons, moving a solid mass of atoms continuously past a source of neutrons, and vibrating a mass of atoms in the vicinity of a source of neutrons. In the case of vibration, such embodiments may optionally be accomplished in combination with a synchronized pulsing system in which the neutron stream is turned off except when the direction of the vibration is in the favored direction. In the latter example of an embodiment, the use of a linearly vibrating collection of atoms without the use of a synchronized pulsing system will result in momentum transfer favoring both directions along a line parallel to the axis of vibration, in essence a “bi-directional” beam. If a synchronized pulsing system is used in a linearly-vibrated arrangement, the result will be momentum transfer favoring only one direction, essentially approximating a “ray” or “uni-directional” beam. Each of the latter embodiments has potential use. For example, the bi-directional beam may be applicable to minerals identification, such as when mounted on a vehicle moving through a mine shaft, and used to illuminate both sides of the shaft simultaneously during a scan for the presence of substances of interest. For another example, the uni-directional beam may be applicable to explosives detection or to cancer therapy or medical imaging, where there would be no presumption of more than one area needing illumination/interrogation at a time.

Additional favorable momentum transfer conditions are realized in cases where the neutrons are cold, rather than thermal. Average neutron speed decreases as the square root of temperature. Thus, a reduction of neutron temperature from 298.16 K to, for example, the temperature of liquid hydrogen, 20.27 K, reduces their mean velocity to 574 m/sec, a nearly fourfold reduction. Cold neutrons will be warmed, on balance, by the use of momentum transfer from an atomic collection.

The invention therefore relates generally to moving a collection of atoms or nuclei suitable for transfer of momentum in a preferred direction to thermal, epithermal, or cold neutrons by way of elastic scattering events. The moving collection of atoms collides with some or all of the neutrons in the isotropically emitted neutron beam. These collisions affect and influence the original, isotropic paths of the emitted neutrons, causing them to be at least partially redirected toward a preferred direction. In embodiments employing a vibrating structure as the moving collection, controls may optionally be implemented to interrupt the neutron stream except when the structure is vibrating in the desired direction.

### BRIEF DESCRIPTION OF THE DRAWINGS

These and other features and advantages of the present invention will become more readily appreciated when considered in connection with the following detailed description and appended drawings, wherein:

FIG. 1 is a perspective view showing one exemplary embodiment of the subject invention wherein the apparatus is carried in a land vehicle such that the neutron source is supported in a position for scanning a search area which, in this case, is a roadway having buried therein an improvised explosive device (IED);

FIGS. 2A and 2B show, respectively, forward-looking perspective views as might be encountered by the driver of a vehicle carrying the apparatus and implementing the method of this invention wherein building structures line the sides of a roadway and a parked vehicle lies ahead, with FIG. 2B depicting in exemplary fashion a scanning path for a neutron beam according to the subject invention with a flash-like response representing the generation of gamma rays which occurs when the neutron beam interacts with substances of interest, e.g., nitrogen, in a hostile Area Under Investigation (AUI);

FIG. 3 is a schematic representation of the subject apparatus for detecting remote explosive substances according to one embodiment of this invention, using a uni-directional neutron beam;

FIG. 4 is a speed probability density distribution of neutrons in thermal equilibrium with room temperature materials and, in addition, the speed probability density distributions of several other common nuclei in exemplar gases for comparison;

FIG. 5 shows the phenomenon of elastic scattering using a simple “billiard ball” model;

FIG. 6 shows a first embodiment of an apparatus for beam forming neutrons using momentum transfer in accordance with this invention, in which a supersonic wind tunnel circulates a gas made from suitable atoms;

FIG. 7 shows an alternative embodiment of an apparatus for beam forming neutrons using momentum transfer in accordance with this invention which utilizes multiple high speed rotors made from suitable atoms;

FIG. 8 is yet another alternative embodiment of an apparatus for beam forming neutrons using momentum transfer in accordance with this disclosure, wherein a vibrating enclosure made from suitable atoms supports a longitudinal bulk acoustic wave, and where the neutron source is switched off except when the translational component of the bulk acoustic wave in the vicinity of the neutron source is traveling the preferred direction;

FIG. 9 relates to the embodiment of FIG. 8 and illustrates the optional synchronization between the acoustic wave and the pulsed neutron beam so as to create a uni-directional beam;

FIG. 10 is a schematic representation of another exemplary application of the subject apparatus as shown in FIG. 8 for detecting the presence of elements in a mine shaft, using a bi-directional neutron beam;

FIG. 11 shows yet another exemplary application of the subject apparatus as shown in FIG. 8 wherein a uni-directional neutron beam illuminates a suitably stained human brain tumor in a therapeutic setting; and

FIG. 12 is a schematic representation of another exemplary application of the subject apparatus as shown in FIG. 8 for grading coal as it moves along a conveyor belt, using a uni-directional neutron beam.

### DETAILED DESCRIPTION OF THE PREFERED EMBODIMENTS

References in this document to “one embodiment”, “an embodiment”, “some embodiments”, or similar linguistic formulations means that a particular feature, structure, operation, or characteristic described in connection with those embodiments is included in at least one embodiment of the present invention. Thus, the appearances of such phrases or linguistic formulations in this document do not necessarily refer to the same embodiment. Further, various particular features, structures, operations, or characteristics may be combined in any suitable manner in one or more embodiments.

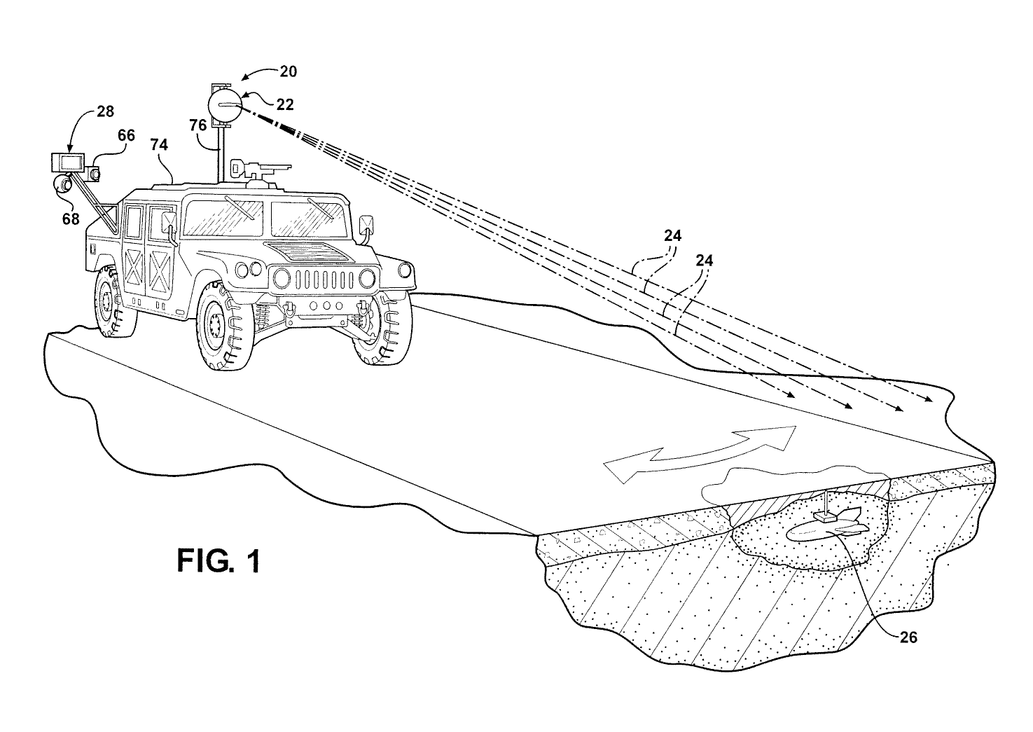

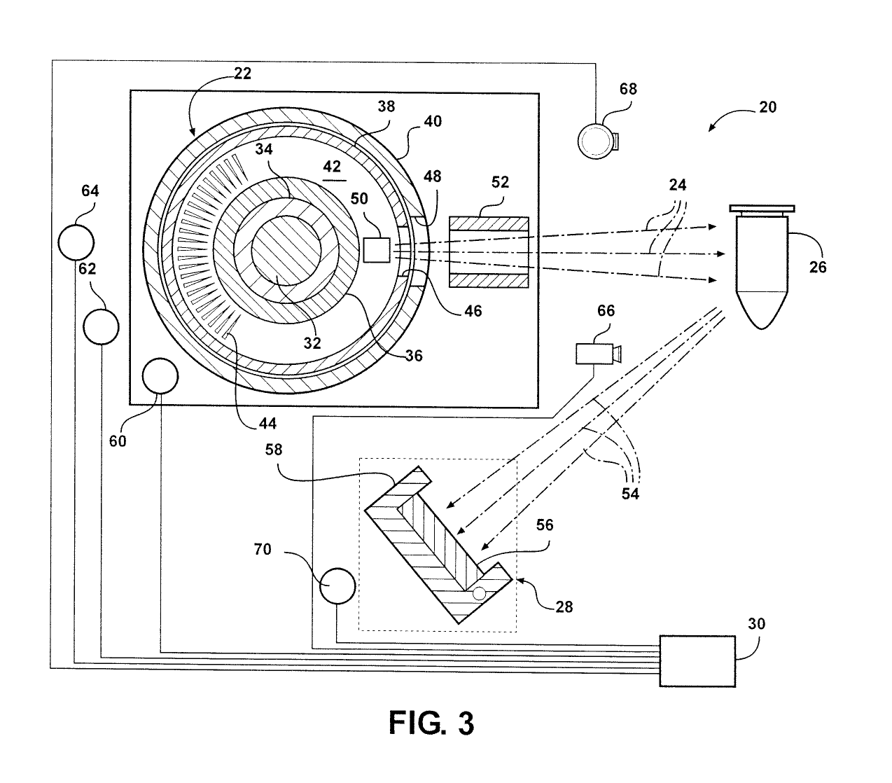

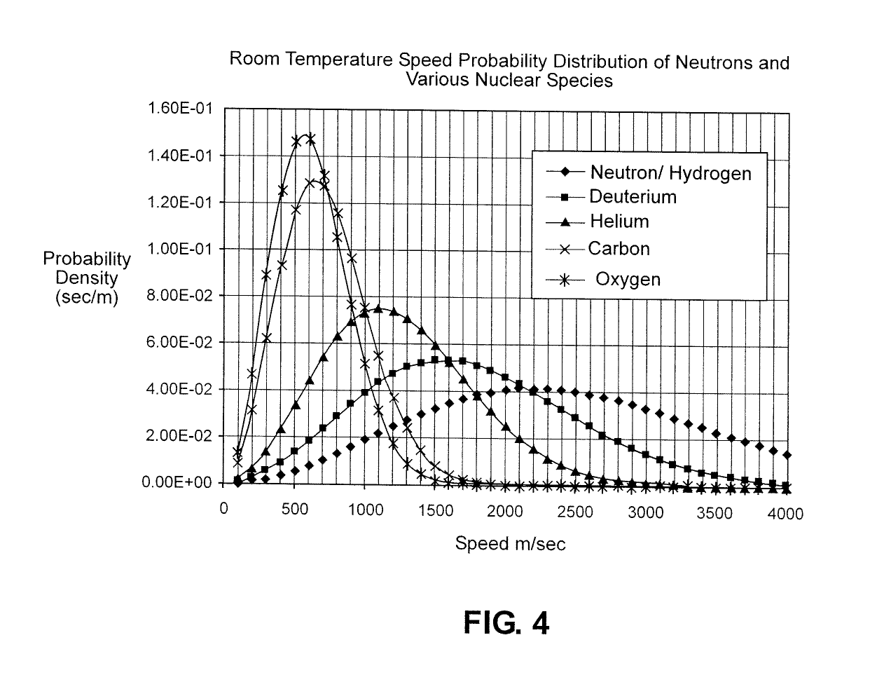

FIGS. 1 and 3 illustrate graphically an exemplary apparatus 20 for detecting remote explosive substances in accordance with one embodiment of the present invention. (Conventional elements, such as housings, mountings, supports, electrical power supplies, etc. are shown in greatly simplified form or omitted altogether for ease of illustration.) The apparatus 20 has a neutron beam generator 22, which directs a neutron beam 24 across a search area. Everywhere the neutron beam 24 interrogates (i.e., illuminates) may be considered an Area Under Investigation (AUI) 26. The AUI 26 is either suspected to contain a substance of interest or is known to contain a substance of interest that will react favorably to the interrogating neutron beam. In some applications of the technology, an AUI 26 may be generally defined as a hostile, hidden or suspicious object that has the potential to harm people or property. In this context, the AUI 26 may be an improvised explosive device (TED) or bomb, although in other embodiments, it may be valuable minerals of interest or perhaps a suitably stained human brain tumor in a therapeutic setting. The apparatus 20 also includes a gamma ray detector 28 and a plurality of data collection modules and sensors (described in more detail below), along with a detection processing module 30. These several main components of the apparatus 20 are first broadly described by their sub-components, and then each sub-component is described in further detail.

The neutron beam generator 22 directs a neutron beam 24 along a vector towards the search area. As shown schematically in FIG. 3, a fast neutron source 32 is surrounded by an optional neutron amplifier 34, which increases the number of fast neutrons prior to their moderation. The optional neutron amplifier 34 is surrounded by a neutron moderator 36, which slows some or all of the fast neutrons to thermal, epithermal, or cold energies. A movable, e.g., rotatable, neutron shield system 38, 40 enclose a void 42. The neutron moderator 36, optional neutron amplifier 34, and the fast neutron source 32 are contained within the void 42. Also located in the void 42 is an optional neutron focusing element 44. Each of the movable neutron shields 38, 40 defines an aperture, apertures 46 and 48 respectively, which cooperate as a beam former to direct the neutron beam 24 along a vector. In other words, the overlap between the first 46 and second 48 apertures allows a projected beam 24 of neutrons to escape from the generator 22 so that the beam 24 can be scanned across a search area suspected to contain one or more substances of interest. An optional neutron amplifier 50 within the void 42 and immediately before the overlapped region of the apertures 46, 48 can be used to increase the number of neutrons in the neutron beam 24. A neutron beam-foaming component 52, situated along a path of the neutron beam 24, can be used in cooperation with the apertures 46, 48 to further focus the neutron beam 24. Various examples of a neutron beam-forming component 52 are described below in connection with the several embodiments of this invention.

The gamma ray detector 28 is used to detect gamma rays 54 emitted from the remote AUI 26. Preferably, the gamma ray detector 28 may be spaced apart from the neutron beam generator 22 by several meters, e.g., two meters. Substances of interest, if present within the remote AUI 26, will radiate gamma rays 54 with characteristic emission spectra when bombarded by neutrons. A portion of these gamma rays 54 are intercepted by a gamma ray spectrometer 56 portion of the gamma ray detector 28. The spectrometer 56 is shielded from nuisance gamma rays originating from sources other than the remote AUI 26 by a gamma ray shield 58.

Neutron source status information is collected from a plurality of sensors within or near the neutron source 32 and reported via data channel 60. Furthermore, two position sensors 62 and 64, one for each shield 38, 40, monitor the instantaneous positions of the respective shields 38 and 40, and therefore are capable of discerning the vector position or orientation of the neutron beam 24 at any moment in time. An optional imaging sensor (e.g., a video camera or its functional equivalent) 66 may be provided, along with a distance sensor 68, and a detection data collection module 70. The two position sensors 62, 64 determine the positions of the two apertures 46, 48, respectively. Each of the two position sensors 62, 64, the data channel 60, the optional imaging sensor 66, and the distance sensor 68 collects and transmits its data to the detection processing module 30. The detection data collection module 70 collects and transmits the data from the gamma ray detector 28 to the detection processing module 30. The position sensor 62 (and likewise 64) can be of the well-known encoder-type which may be either separately fitted to some movable portion of either shield 38, 40, or may be incorporated directly into the motor drive system which controls movement of the respective shields 38, 40.

The optional imaging sensor 66 also allows for the system to be switched off temporarily, either manually or automatically, if the imaging sensor detects the images of civilians or other sensitive elements in the scene downrange of the neutron beam. After determining that the area is clear of sensitive elements, the beam can be switched on again, either manually or automatically.

The detection processing module 30 processes data, including but not limited to neutron source status information collected from a plurality of sensors within the neutron source and reported via data channel 60, position data provided from the two position sensors 62, 64, the optional imaging sensor 66, the distance sensor 68, and the detection data collection module 70. Based on the provided data, the detection processing module 30 determines whether the remote AUI 26 contains any substances of interest, as well as the location of the remote AUI 26 by inference from the orientation of the beam vector at the moment in time when the gamma ray detector 28 senses the incoming gamma rays 54 from the AUI 26.

A compact fast neutron source 32 may be preferred because it is portable, simple to construct, and a convenient source of significant neutron flux. Alternative types of such neutron sources 32 may be used in various circumstances. For portable field operations, the maximum dimension of the neutron source 32 should be minimized to the extent practical. Numerous types of known fast neutron sources have a maximum dimension smaller than approximately 300 cm, as is desirable here, including but not limited to spontaneous fission radioisotopes, accelerator-based sources, alpha reactions, photofission, and plasma pinch. Some embodiments have spontaneous fission neutron sources using radioactive isotopes, such as Californium-252 (₉₈Cf²⁵²). In some embodiments, neutrons are produced by sealed tube or accelerator-based neutron generators. These generators create neutrons by colliding deuteron or triton beams into AUIs containing deuterium or tritium, causing fusion with attendant release of neutrons. Some embodiments have alpha reaction sources, in which alpha particles from alpha-radioactive isotopes, such as polonium or radium, are directed into AUIs made of low-atomic-mass isotopes, such as beryllium, carbon, or oxygen. An embodiment may also use photofission sources, including beryllium, in which gamma rays are directed into nuclei capable of emitting neutrons under certain conditions. Another kind of neutron source is the plasma pinch neutron source or fusor source, in which a gas containing deuterium, tritium, or both is squeezed into a small volume plasma, resulting in controlled nuclear fission with attendant release of neutrons. Pulsed neutron generators using the fusor technique are also commercially available.

As shown in FIG. 3, the fast neutron source 32 is preferably surrounded by a conventional neutron amplifier 34, which increases the number of fast neutrons prior to their moderation by the neutron moderator 36. Neutron amplifiers 34 emit more neutrons than they absorb when irradiated by neutrons. Known materials used as fast neutron amplifiers include, but are not limited to, thorium, lead, beryllium, americium, and non-weapons-grade uranium and plutonium. Since the most common neutron amplifiers 34 operate on high energy neutrons, some embodiments may include one or more high energy neutron amplifiers or pre-moderator amplifiers, thereby maximizing the number of neutrons in the neutron beam for a given power dissipation, physical size, cost, and weight. Other types of neutron amplifiers 34 which may be used for this invention operate on thermal energy neutrons. Therefore, some embodiments may include a thermal neutron or post-moderator amplifier 50 as well.

Because the neutrons produced by the fast neutron source 32 and the optional pre-moderator amplification stage 34 have energies tens to hundreds of millions of times larger than the energies required for thermal, epithermal, or cold neutrons in the present apparatus 20, some or all of the neutrons may be slowed down to those energy ranges—energies in thermal equilibrium with nominally room temperature surroundings (0.026 eV) or energies somewhat above or below thermal energies—by the neutron moderator 36. This process is known as neutron moderation or thermalization.

Neutron moderation is conventionally achieved by scattering or colliding the neutrons elastically off light nuclei that either do not absorb them or else absorb them minimally. Since the light nuclei are of the same rough order of magnitude in mass as the neutrons themselves, each neutron imparts significant energy to each nucleus with which it collides, resulting in rapid energy loss by the neutrons. When the neutrons are in thermal equilibrium with their surroundings, a given neutron is just as likely to get an energy boost from a slightly faster-than-average nucleus as it is to lose a slight amount of energy to a slightly slower-than-normal molecule. As a result, neutrons in thermal equilibrium with their surroundings remain in equilibrium. Among the most effective moderator nuclei are deuterium and carbon-12, since they are light and do not absorb appreciable number of neutrons. Light hydrogen is also an effective moderator because, although it absorbs a small number of neutrons, its extremely low atomic weight of 1 allows for extremely efficient moderation. Polyethylene, containing carbon and light hydrogen, is thus an effective moderator compound as well.

As shown in FIG. 3, neutron moderation can be achieved by passing fast neutrons emanating from the source 32 through the neutron moderator 36. Some of the optional types of neutron sources mentioned above produce neutron beams (anisotropic sources), while others produce neutrons with trajectories radiating equally in all directions (isotropic sources). Nevertheless, the effect of moderation, with its numerous elastic scattering events per moderated neutron, yields a fairly isotropic distribution of neutron trajectories. For this reason, one particularly desirable shape for the neutron moderator 36 is a hollow sphere with the fast neutron source 32 and the optional pre-moderator amplifier 34 inside. For a deuterium oxide (“heavy water”) moderator 36, the thickness required to moderate nearly 100% of deuterium-deuterium fusor-source neutrons having energies of the order of 2.45 MeV to thermal energies is of the order of 30 cm; for a graphite moderator, the thickness is greater. See, e.g. G. Friedlander et al, Nuclear and Radiochemistry (3d ed., Wiley and Sons 1981). The actual moderator 36 may be thinner than this, if some energetic neutrons are to be left in the beam 24.

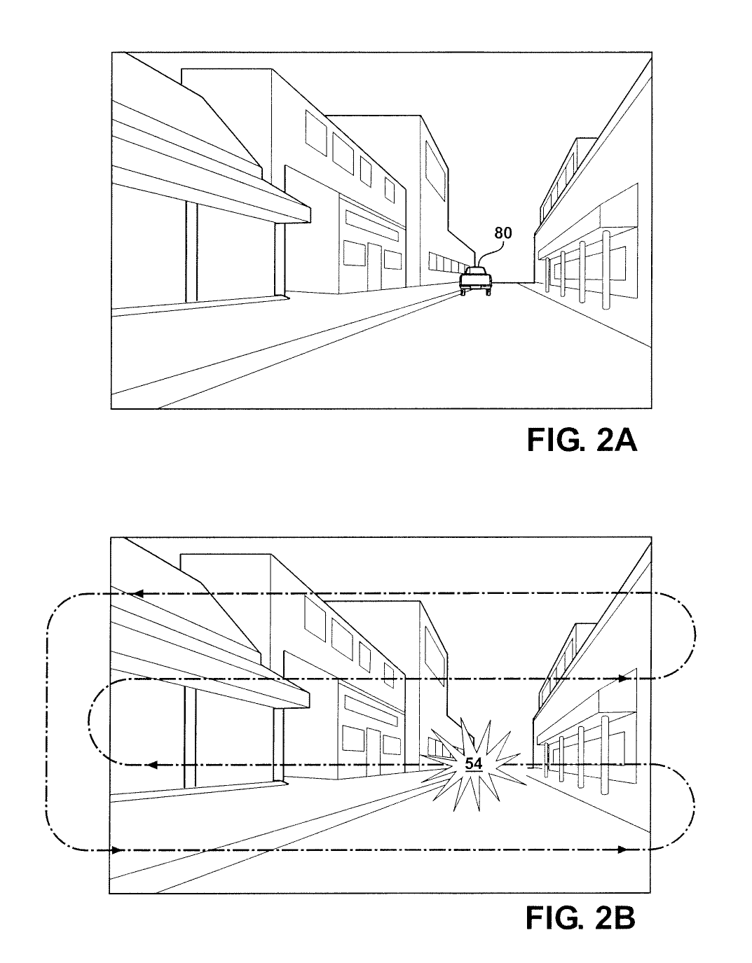

Simply sending thermal neutrons into space in all directions would not allow a substance of interest to be located spatially within a search area. For this reason, it is useful to scan the surrounding landscape with neutron beam 24. FIG. 2A is an exemplary perspective view as may be perceived by a person operating the subject apparatus 20. In the most practical embodiment of this invention, the apparatus 20 is mounted on a mobile carrier 74 which, as shown in FIG. 1, may take the form of an armored land vehicle. However, other carrier 74 embodiments can be envisioned, including tailored land vehicles, marine vessels, aircraft and the like. In other words, the carrier 74 may comprise any structure capable of supporting the neutron source 32 opposite a search area. Thus, in FIG. 2A, the perspective view may be that of an area suspected to contain one or more hostile AUIs such as bombs or explosive devices which could be hidden in any conceivable location below the ground, on the ground or above the ground. Thus, as the search area is approached, an operator of the apparatus 20 upon perceiving the view presented in FIG. 2A, will not be able to accurately predict where a substance of interest may reside, and therefore the entire region may be methodically interrogated. During the time each small area or object is interrogated with the neutron beam 24, that area or object is the AUI 26. For this reason, the apparatus 20 is constructed so that the neutron beam 24 can be scanned across the search area or otherwise methodically interrogate each suspected hiding place for substances of interest. For example, the circuitous dashed lines in FIG. 2B represent a methodical, serpentine-like back-and-forth scanning of the search area with the neutron beam 24 over a defined period of time. In other words, if for example a motor carrier 74 were stationary, the back-and-forth scanning of the search area may take the form illustrated in FIG. 2B. Of course, other scan path methodologies can be used including up-and-down, circular, zig-zag or other scanning patterns as may be deemed appropriate. In these examples, a hostile target, e.g., IED, is hidden within a vehicle 80 parked along the roadside in the search area and contains a substance of interest, e.g., nitrogen. When the neutron beam 24 interrogates the vehicle 80 as an AUI 26, a flash of gamma rays 54 is produced because this particular AUI contains the particular substance of interest, nitrogen in this case. The fluoresced gamma rays 54 are detected by the gamma ray detector 28. The position sensors 62, 64 are effective to specify the orientation of the neutron beam vector at the moment the gamma rays 54 are detected by the detector 28 so as to locate the substance-containing AUI 26 in the search area. Of course, means other than the position sensors 62, 64 may be used to infer the location of the substance of interest, especially in cases where the shielding system is not rotatable.

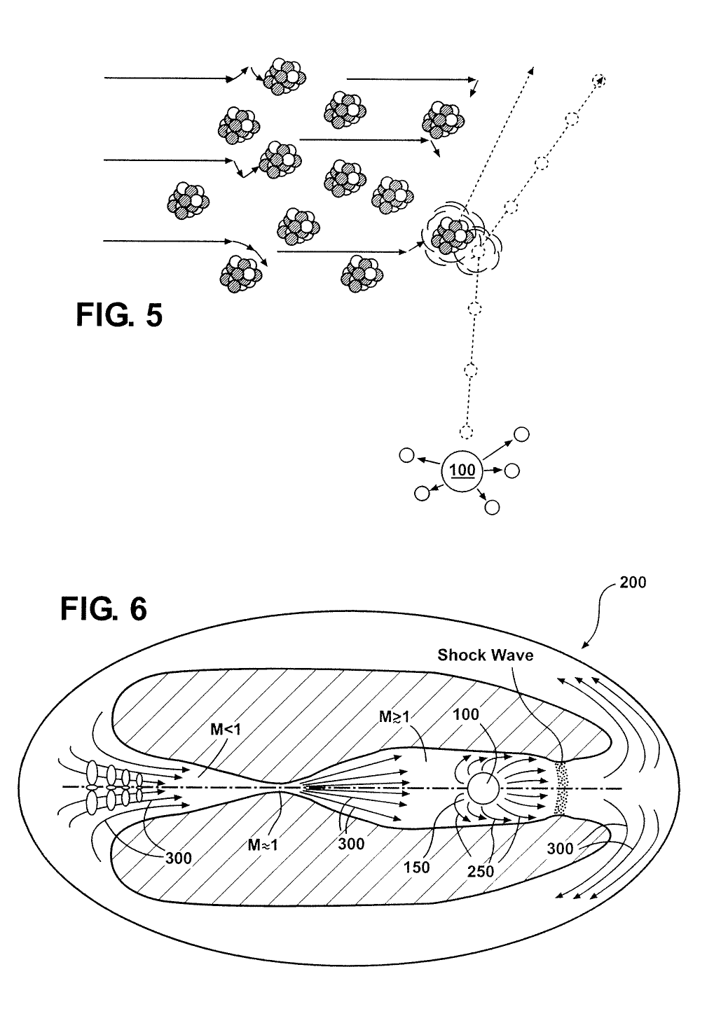

FIG. 5 shows the speed probability density distribution of neutrons in thermal equilibrium with room temperature materials (298.16 K) (i.e., thermal neutrons) and, in addition, the speed probability density distributions of several other common nuclei in exemplar gases for comparison. This invention relates generally to improvements related to the neutron beam-forming component 52 and other related features as shown schematically in FIG. 3.

FIG. 6 illustrates graphically a first embodiment of this invention for beam forming neutrons using momentum transfer, wherein new reference numbers are ascribed for the sake of clarity. Conventional elements, such as housings, mountings, supports, electrical power supplies, external radiation shielding, etc. are omitted from view in FIG. 6. The beam-forming component 52 in this example has three notable components: a neutron source 100, a conventional supersonic wind tunnel 200, and a momentum transfer fluid 300. The momentum transfer fluid 300 is preferably a suitable gas, however suitable liquids may also be used in appropriate conditions.

The neutron source 100 is located in the high-speed test section of supersonic wind tunnel 200, where it emits neutrons 150 isotropically. By high speed, it is intended that, preferably, the neutron source 100 is located within the region where the Mach number of the gas is greater than 1. As can be seen from FIG. 6, a portion of the neutrons are steered toward the direction of interest by the method of momentum transfer from the gas, becoming beam formed neutrons 250. For clarity, neutrons that escape elastic collisions, and therefore are not steered or beam formed, are not shown. The supersonic wind tunnel 200 accelerates the momentum transfer gas 300 through Mach 1 inside the wind tunnel's sonic throat to supersonic speeds (M>1) in the test section. The gas decelerates to below Mach 1 in the exit throat, after which it recirculates.

During operation, the momentum transfer gas 300 is accelerated by means of the wind tunnel's impeller turbine into the wind tunnel's sonic throat, where it accelerates to Mach 1 for the particular choice of momentum transfer gas: 850 m/sec in deuterium, 927 m/sec in helium, 316 m/sec in oxygen, 490 in deuterium oxide vapor, 259 m/sec in carbon dioxide, and 440 m/sec in deuterated methane (compare to 343 m/sec in air). In other words, the momentum transfer gas 300 includes a collection of atoms suitable to accomplish momentum transfer according to the principles of this invention. The momentum transfer gas 300 accelerates to speeds greater than Mach 1 as it expands in the test section, to practical limits approaching Mach 5. The isotropic neutron source 100 is located in this high speed test section, where the linear momentum of the gas stream is imparted to the isotropically emitted neutrons 150, causing some of them to become anisotropic or beam-formed neutrons 250, with velocity vectors tending toward the direction of gas flow. The momentum transfer gas then decelerates through a shock wave in the exit throat of the wind tunnel, after which the gas is diverted back to the impeller turbine for its next cycle.

It should be understood that, although in the preferred implementation of this embodiment utilizes a supersonic wind tunnel, variations may be envisioned in which the wind tunnel is constructed and operated for either transonic or subsonic applications.

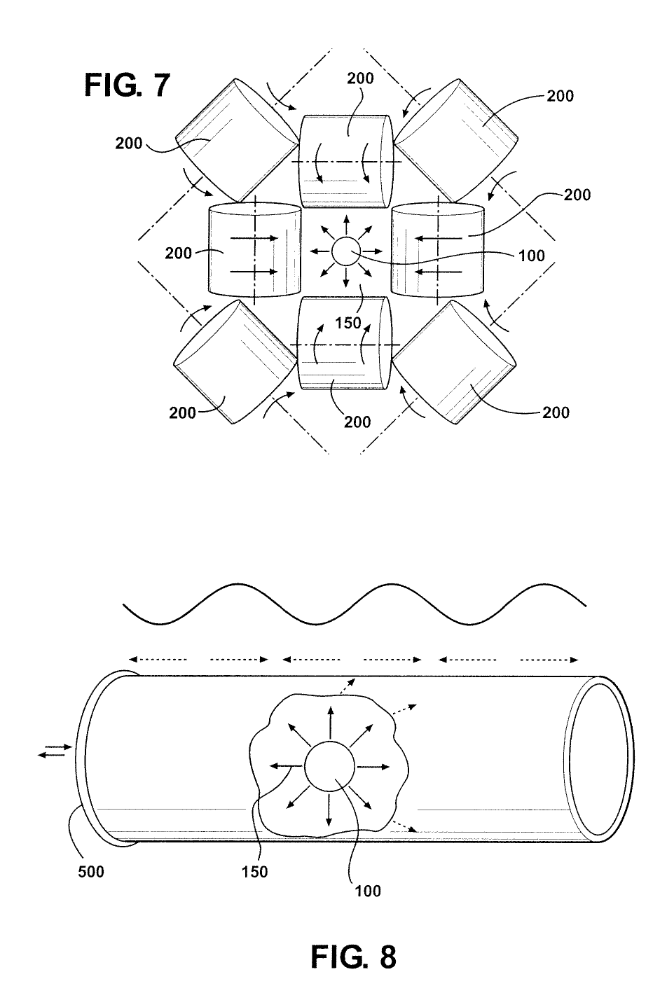

FIG. 7 illustrates graphically an apparatus for beam forming neutrons using momentum transfer in accordance with another embodiment of the present invention. As with the first described embodiment, conventional elements, such as housings, mountings, supports, electrical power supplies, external radiation shielding, etc. are omitted. The apparatus of this embodiment includes a neutron source 100 and a plurality of rollers 310. For clarity, beam formed neutrons are not shown. These two main components are first broadly described by their sub-components, and then each sub-component is described in detail. As in the preceding embodiment, the neutron source 100 emits neutrons isotropically and is located strategically relative to, e.g., in the center of, the plurality of rollers 310.

The plurality of rapidly rotating cylindrical rotors 310 may be made from a suitable solid material, such as graphite, graphite composite, carbon nanostructures, or deuterated polyethylene. In other words, the rotors 310 each include a collection of atoms suitable to accomplish momentum transfer according to the principles of this invention. Eight such rollers 310 are shown in FIG. 7, all of them supported for rotation about coplanar axes, but this number and arrangement is merely illustrative of one possible configuration. The rollers 310 may be constructed of uniform, homogeneous material, or they may be constructed of a multiplicity of materials combined in any way, including but not limited to composite structures, laminated structures, and containers filled with both solid-phase and liquid-phase materials.

Neutrons that experience elastic collisions with the atoms making up the cylinders 310 on the side nearest to their respective axes of rotation receive a net transfer of linear momentum in the direction of the angular velocity of the rotors 310, causing them to become anisotropic or beam-formed in the favored direction. In FIG. 7, the favored direction is toward the plane of the paper. Beam-formed neutrons are not shown for clarity. Although neutrons that reach points past the axes of the rotors receive a net transfer of momentum in non-favored directions, the flux of neutrons experiencing this condition is smaller than that available for beam forming in the preferred direction, since the flux reaching past the axes has been diminished by the removal of neutrons that have been beam-formed successfully. For that reason, the net effect of the device and embodiment described is to enhance neutron flux in the preferred direction.

While momentum transfer occurs at any rotor speed, the efficiency of overall beam forming increases as the linear or centripetal speed of the rotors 310 approaches or exceeds the mean speed of the neutrons used. Maximum rotational speeds for rotors 310 are typically determined by their failure due to centrifugal force producing radial deformation—such rotors 310 fail in tension in the radial direction. Carbon fiber composites have been demonstrated with 500 m/sec angular velocity limitations, approximating the speed of cold neutrons in thermal equilibrium with liquid hydrogen. It is thus clear that achievable rotor speeds correlate with neutron speed ranges of interest and usefulness.

FIG. 8 illustrates graphically an apparatus for beam forming neutrons using momentum transfer in accordance with yet another embodiment of the present invention. As with the previous two described embodiments, conventional elements, such as housings, mountings, supports, electrical power supplies, external radiation shielding, etc. are omitted for ease of illustration. The apparatus includes a switchable, i.e., pulsed, neutron source 100. Preferably, the source 100 is capable of being switched between different power or flux levels, including but not limited to power settings OFF and ON, 90% and 10%, etc, it being understood that the terms OFF and ON refer to “Full or nearly full neutron flux” and “zero or nearly zero neutron flux”, respectively. As before, the neutron source 100 emits neutrons isotropically 150 and is preferably located inside a tube 320. The tube 320 is constructed of a suitable material, such as graphite laminate composite, carbon nanostructure material, or deuterated polyethylene. In other words, the tube 320 includes a collection of atoms suitable to accomplish momentum transfer according to the principles of this invention.

FIG. 8 shows a cylindrical tube 320, but this geometry is merely illustrative of one of many that are possible. Other embodiments of the tube 320 could include arrangements of other shapes, such as flat plates, angles, semi-tubes, or combinations of these and other shapes, including multiple layers. A mechanical transducer 500 or other suitable device is provided to vibrate the tube 320 along its longitudinal axis. More specifically, one or more mechanical transducer(s) 500 are attached to an end of the tube 320 or other suitable location. FIG. 8 shows a single transducer attached to a single tube, but this arrangement is merely illustrative of any of many possible arrangements of components that could exist in numerous embodiments of the described apparatus.

The transducer 500 is used to vibrate the tube 320 back and forth (i.e., linearly) along its longitudinal axis. The combination of the transducer 500 and tube 320 may be either rigidly or compliantly mounted to a supporting structure or not, for impedance coupling, and the vibrations thus produced may result in either a traveling or standing wave in the tube or its equivalent. The vibrations cause the nuclei of the material from which the tube or its equivalent is constructed to move backward and forward longitudinally. In other contemplated embodiments, vibrations are induced in non-linear fashion such as in arcuate or complex motion paths.

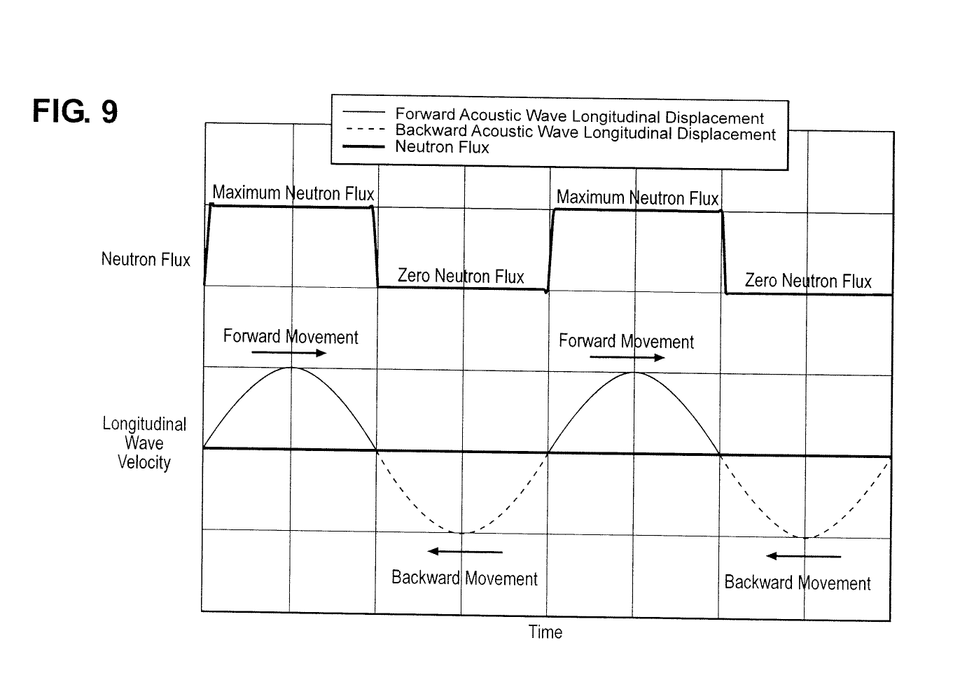

As illustrated in FIG. 9, the neutron source 100 is preferably switched between power settings in such a way that neutrons are emitted only when the atoms of the tube 320 are moving in the forward direction. Neutrons experiencing elastic collisions with the atoms of the tube 320 receive a net transfer of linear momentum in the direction the atoms are moving. By switching the neutron source 100 off at times when the collection of atoms of the tube 320 are moving in an adverse direction, neutrons are only released during favorable wall movement. The result is that the flux of neutrons has the greatest chance of maximum favorable momentum transfer and the least chance of unfavorable momentum transfer.

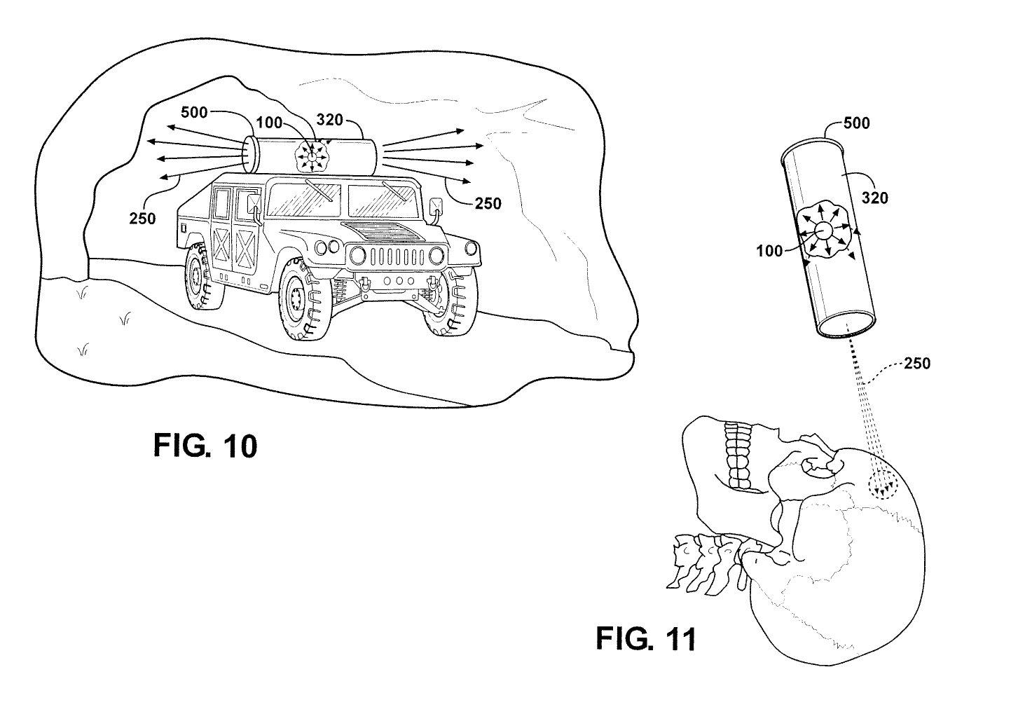

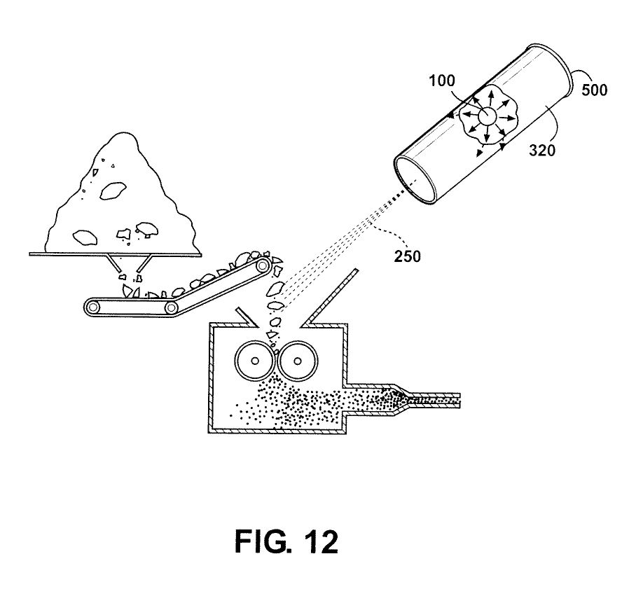

Note that this operation could be conducted on the surface, and the area being scanned could be undisturbed ground, mining tailing piles, cliff faces, scraped ground, or other types of topology. For example, FIG. 10 shows the apparatus of FIG. 8 applied for detecting the presence of elements in a mine shaft, using a bi-directional neutron beam. Such bi-directional beam 250 can be accomplished by not modulating the neutron beam in relation to the vibration directions. In this manner, the linear vibrating tube 320 can be made to focus neutrons in linear directions, and thus allow simultaneous scanning of both sides of a cave, street or other search area. For example, while bi-directional searching may not be favored for manned explosives detection operations, it might be acceptable for other types of operations, such as searching for hidden non-explosive contraband, valuable minerals, and the like. FIG. 11 shows a non-search application of the subject invention wherein the location and presence of a substance of interest in the AUI is known. In this case, the substance of interest, for example boron, has been medically introduced into the body of a patient for the purpose of staining a tumor in the patient's brain. The boron will give off gamma rays when suitably illuminated with a neutron beam 250, which interaction may have certain favorable therapeutic effects in the treatment of the tumor. Here, a focused uni-directional neutron beam 250 emitted from the apparatus is accomplished by intentionally modulating the neutron source 100 in relation to the linear vibration directions of the tube 320 as described above in connection with FIG. 8. Of course, many other applications of this technology will be understood by those of skill in the art, including for another example FIG. 12 in which the apparatus of FIG. 8 is applied for grading coal as it moves along a conveyor belt, using a uni-directional neutron beam 250.

While the present invention has been described in terms of the above-described embodiments and apparatuses, those skilled in the art will recognize that the invention is not limited to the embodiments described. The present invention may be practiced with various modifications and alterations within the spirit of the appended claims.

What is claimed is:

1. An apparatus for focusing thermal, epithermal, and cold neutron beams toward an Area Under Investigation (AUI) using momentum transfer, said apparatus comprising:
a neutron source for producing a generally isotropic emission of neutrons;
a beam former for directing a least some of said neutrons emitted from said neutron source toward an AUI;
said beam former containing a collection of atoms suitable to impart momentum transfer to the neutron beam,
and said beam former arranged so as to move said collection of suitable atoms in a preferred direction to effect a transfer of momentum from the collection of atoms to the neutrons in the preferred direction by way of elastic scattering events.

2. The apparatus of claim 1, including a controller for switching said neutron source between at least two distinct neutron flux settings.

3. The apparatus of claim 2, wherein said controller is capable of switching said neutron source between OFF and ON conditions.

4. The apparatus of claim 1, wherein said collection of suitable atoms is sustained in a gaseous phase.

5. The apparatus of claim 1, wherein said collection of suitable atoms is sustained in a liquid phase.

6. The apparatus of claim 1, wherein said collection of suitable atoms is sustained in a solid phase.

7. The apparatus of claim 1, wherein said collection of suitable atoms is sustained in a plasma phase.

8. The apparatus of claim 1 wherein said beam former includes a wind tunnel.

9. The apparatus of claim 1 wherein said beam former includes at least one roller.

10. The apparatus of claim 9 wherein said at least one roller is generally cylindrical.

11. The apparatus of claim 9 wherein said at least one roller is fabricated from a materials selected from the group consisting essentially of: carbon nanostructures and carbon fiber.

12. The apparatus of claim 9 wherein said at least one roller comprises a plurality of said rollers supported from rotation about respective, co-planar axes.

13. The apparatus of claim 1 wherein said beam former includes a vibrating structure.

14. The apparatus of claim 13 wherein said vibrating structure comprises a vibrated tube.

15. The apparatus of claim 14 wherein said vibrating structure is fabricated from a material selected from a group consisting essentially of: graphite, graphite composites, carbon fibers, and carbon nanostructures.

16. The apparatus of claim 1 wherein said collection of suitable atoms are selected from the group consisting essentially of: Deuterium, Helium, Carbon, and Oxygen.

17. An apparatus for focusing a neutron beam toward an Area Under Investigation (AUI) using momentum transfer, said apparatus comprising:
a neutron source for producing neutrons capable of generating gamma rays upon interaction with a substance of interest when present in the AUI;
a beam former for directing neutrons emitted from said neutron source toward the AUI, said beam former containing atoms suitable to impart momentum transfer to the neutron beam;
a gamma ray detector for detecting gamma rays emanating from a AUI in the search area;
said beam former including a vibrating structure; and
a controller for switching said neutron source between at least two distinct neutron flux settings.

18. A method for illuminating an Area Under Investigation (AUI) with a focused neutron beam from a remote distance, comprising the steps of:
producing thermal, epithermal, or cold neutrons from a neutron source;
forming at least some of the neutrons into a beam to be projected toward a search area;
providing a collection of suitable atoms moving in a preferred direction toward the AUI;
said forming step including colliding the collection of suitable atoms with the produced neutrons and thereby transferring momentum from the collection of suitable atoms to the produced neurons so as to direct at least some of the neutrons to move in the preferred direction by way of elastic scattering events.

19. The method of claim 18, wherein said step of producing neutrons includes switching between at least two distinct neutron flux settings.

20. The method of claim 18, wherein said wherein said step of moving a collection of suitable atoms includes a recirculating gaseous substance.

21. The method of claim 18, wherein said step of moving a collection of suitable atoms includes a rotating a solid substance.

22. The method of claim 18, wherein said step of moving a collection of suitable atoms includes a vibrating a solid substance.

23. The method of claim 22, wherein said step of vibrating a solid structure includes sustaining a bulk acoustic wave in response to linear stimulus.

24. The method of claim 17, further including the steps of:
producing gamma rays by the interaction of the projected neutron beam with a substance of interest in the AUI;
monitoring for gamma rays with a gamma ray detector; and
scanning the neutron beam across the search area.
